(19) United States
(12) Patent Application Publication
(10) Pub. No.: US 2006/0254857 A1
(43) Pub. Date: Nov. 16, 2006

(54) Cable Ladder Device for High Building Rescue

(75) Inventors: LUDING ZHOU, Nanjing (CN); SHENGPING LI, Nanjing (CN); YI ZHOU, Nanjing (CN)

Correspondence Address: GLOBAL IP SERVICES, 2462 ROCK ST., APT. 6, MOUNTAIN VIEW, CA, 94043, US

(73) Assignee: LUDING ZHOU, Nanjing (CN)

(21) Appl. No.: 11/307,340

(22) Filed: Feb. 1, 2006

(30) Foreign Application Priority Data
Feb. 5, 2005 (CN) 2005100377916

(51) Int. Cl. A62B 1/06

(52) U.S. Cl. 182/142; 182/70

(57) ABSTRACT

A cable ladder device for high building rescue is a rescue devices fixed on the top of the high building or at windows. The rescue devices are controllable for fire engine. It includes cable winder, airbag absorber, ground traction windlass and other components, according to the different installation position, it can be divided into building top cable ladder, building top case-style cable ladder, floor window-style cable ladder and many others. This invention can lift the fireman quickly to mount the building and quick, continuous evacuation of the people inside the building. Furthermore, the invention is also applicable for the cleaning of the outside wall of the high building, quick sliding-down exercise and other aspect.

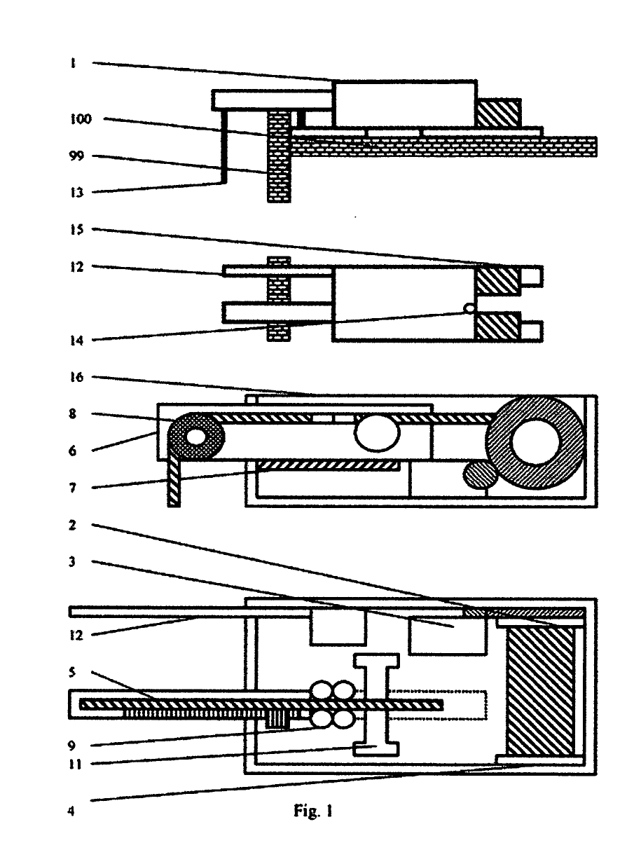

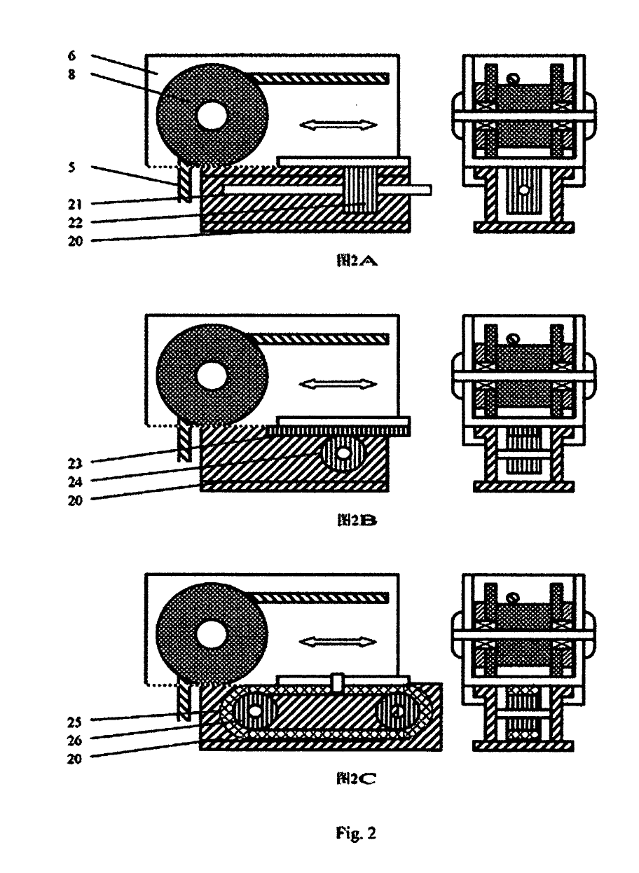

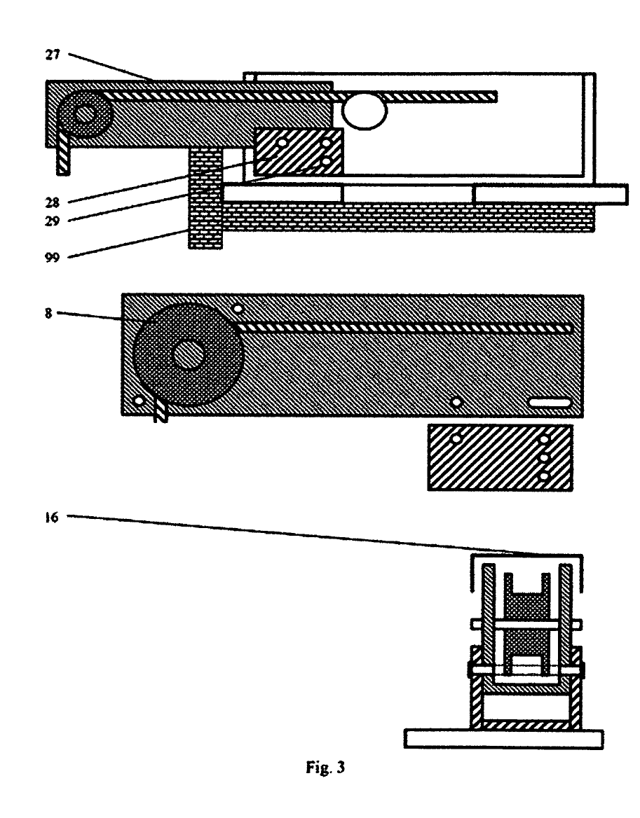

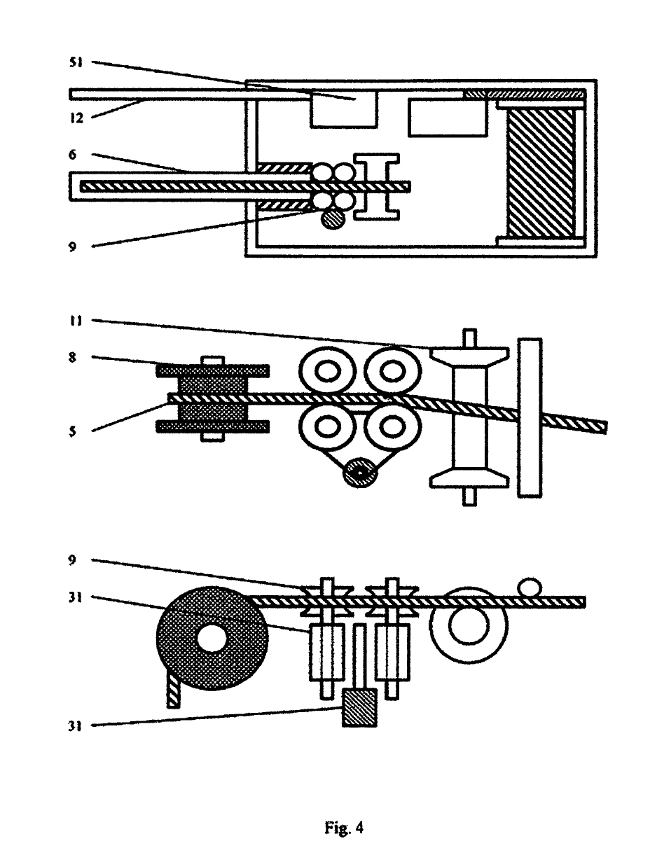

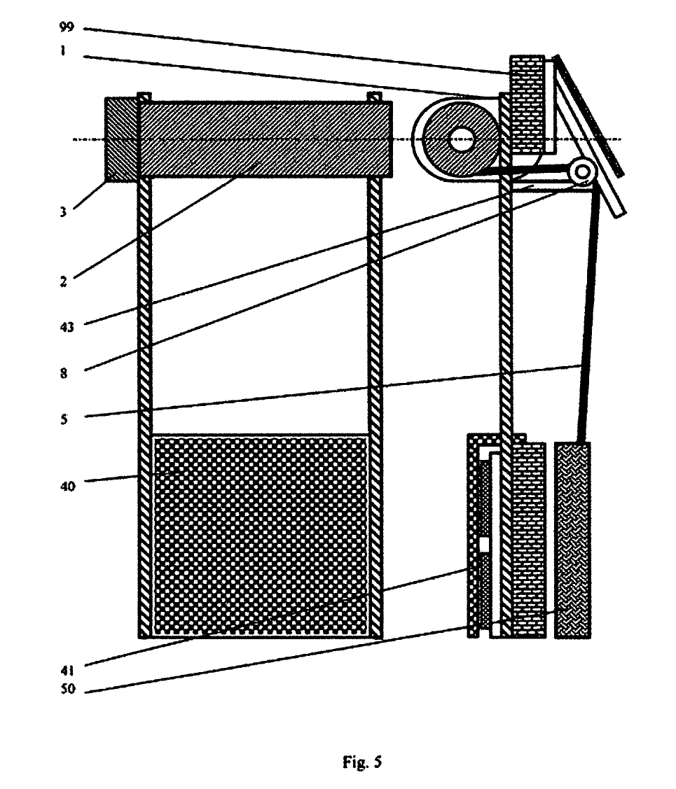

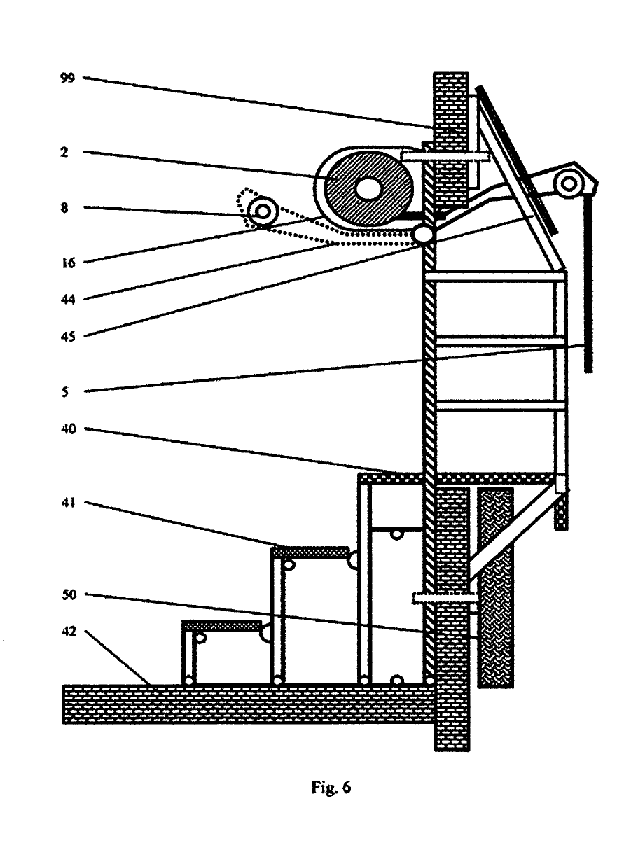

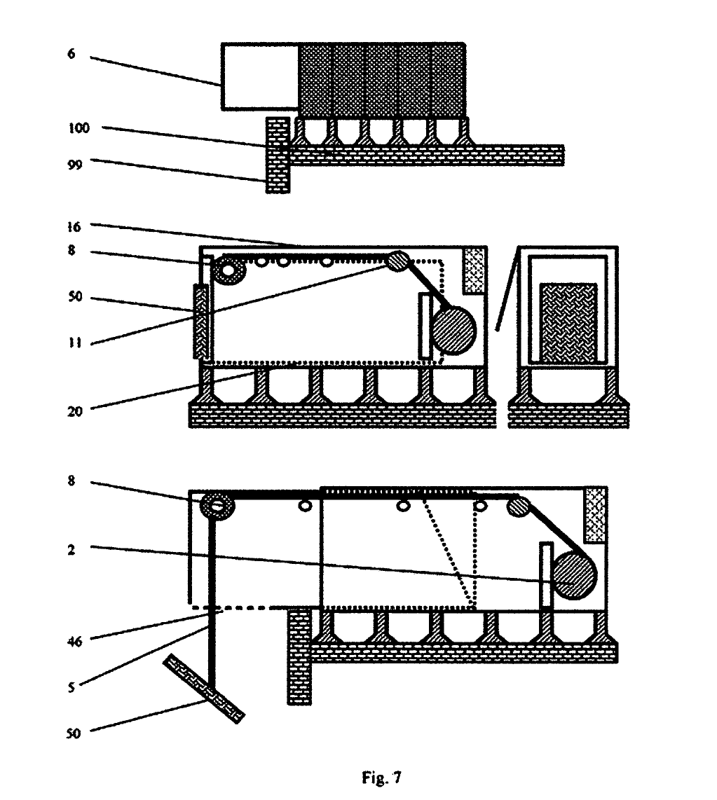

### CROSS REFERENCE TO RELATED APPLICATION

This application claims the priority benefit of a Chinese patent application No. 2005100377916 filed on Feb. 5, 2005.

### FIELD OF THE INVENTION

This invention is concerned with a kind of cable ladder device for high building rescue, especially for rescue devices fixed on the top of the high building or at windows and rescue devices those are controllable by fire engine and the up-and-down movements are realized through cables. This kind of rescue device may allow not only the quick mounting of the fireman, but also the quick and continuous evacuation of the people inside the building from outside building, additionally, the invention is applicable for the cleaning of building, exercise of quick sliding-down, lifting of the objects with large volume and so on.

### BACKGROUND OF THE INVENTION

Once the fire occurred in high building or super-high building, the firemen must mount the build to perform the rescue. Currently, the mounting methods are mainly: helicopter, scaling ladder, fire fighting moving staircase, stairs and so on. Practically, the helicopter is not feasible; the scaling ladder can only reach the height of ten or a litter more floors; the using of fire fighting is dangerous, therefore, in many cases, the firemen usually mount the building through the stairs by their foot.

When the hundreds of people are surging to the stair and escape through the narrow staircase step by step, meanwhile the firemen are mounting through the same narrow and dim staircase with their equipment, in such condition, the disorder and jam will be caused easily.

Generally, the scaling ladder can be used for the building with the height less than 60 feet, but for the super-high building, it beyond reach of the scaling ladder. Up to now, the above problem is existed in the high and super-high buildings of many countries, for there lack of the rescue device which can allow the fireman to mount the building quickly and lack of the escaping device for the quick evacuation of the people inside the building.

The present lifting device also can not suffice the quick mounting, for example:

The present elevators (including the firefighting moving staircases) are dependent on the cable winding by the motor, thereby to draw the case of elevator to perform the vertical up-and-down movement through the track. Once the power is broken off or the serious fire is encountered, the toxic smoke will be sucked in through the crack between the door and its frame for the wind-sucking effect of the elevator shaft, and the power of air feeder will be probably shut off at any time, thus, the people inside the elevator will die. Therefore, it is forbidden by many countries to evacuate the common dwellers through elevators (including firefighting moving staircase).

For the slowness, largeness and the limit of power supply of the present suspending stands for the cleaning of high buildings, these stands can not suffice the quick mounting of fireman, also can not suffice the quick and continuous evacuation of the large number of people in inside the building.

There is also the rope sliding down device used by the individuals, but it is quite dangerous when used on high buildings.

### SUMMARY OF THE INVENTION

Purpose of Invention

The purposes of this invention are: to provide the high, super-high buildings and such architectures with a kind of stock, safe and effective rescues ladder system used for the quick mounting and escaping from outside the building. The system can be controlled in the fire engine, on the ground outside the buildings or the monitoring room of the buildings. The cable ladder device for high building adopts dual-circuit and triple-circuit power supply, automatic switch and control system inside and outside building, the rescue cable of the cable winder is connected with the airbag absorber and windlass. The device has the functions of mounting to rescue, sliding-down to escape, cleaning outside wall, performing exercise and so on.

The addition purposes of this invention are: the cable winder of the rescue ladder device is equipped with the cable winding drum, motor decelerator, detent, cable rack, traction cable rack, also the retractile cable rack which has the function of positioning and locking is equipped, thus the retraction of the retractile cable rack that is caused by the weight of the rescue cable will be avoided.

The addition purposes of this invention are: the device is equipped traction cable rack which can be stretched out synchronically with the retractile cable rack, thus, when the rescue cable is released and lowered, the traction cable which can be used as power cable or traction rope will be lowered at same time, the fireman or the outside wall cleaner in the air can control the up-and-down movement through the traction cable.

The addition purposes of this invention are: the device is equipped with the ground traction windlass, the traction cable can be connected with the underside end of the rescue cable, when the cable winding drum on high building is winding the rescue cable and a group of firemen is mounting the building, the traction windlass which placed a certain safe distance away from the basement of the building can release the traction cable at same time, the proper damp will be kept, the swing of the end of rescue cable's underside is reduced, thus, the bumping between the fireman and wall will be avoided.

The addition purposes of this invention are: the device is equipped with safety protector for quick sliding down evacuation, namely the ground airbag absorber and is adopted pack airbag are adopted to absorb the wallop of the slider and let the slider land safely, the escaper in high building can use the safety backpack sliding-down device to slide down to the airbag absorber along with the rescue cable.

Technology Blueprint

This invention of the cable ladder device for high building rescue is including the parts of cable winder, airbag absorber, ground traction windlass and so on. The cable rack of cable winder can be stretch out a proper distance from the outside wall of high building, it also can release or wind the rescue cable, a safety device and weight are equipped at behind of the cable winder, the whole device is protected by the shield made of stainless steel or other antirust materials; the rescue cable of the cable winder can be connected with the airbag absorber and ground windlass, the airbag absorber can adsorb the wallop of escaper, the ground traction windlass can keep the fireman who on the rescue cable a certain safe distance away from the outside wall of the building. According to the different installing position of the cable ladder device for high building rescue, it can be divided into building top cable ladder, building top case-style cable ladder, floor window-style cable ladder and many others.

The said cable winder is consisted of cable winding drum, decelerator motor, detent, rescue cable, cable rack, cable rack track, cable pulley or track, frictional pulley, vertical pulley shaft, horizontal pulley shaft, traction cable rack and so on; the underside end of the rescue cable can be connected with the airbag absorber on the ground; the cable winder is equipped with a safety device for position monitoring, once the displacement between the chassis of cable winder and the load, safety device will alarm and shut of the power of decelerator motor automatically. The detent can adopt the method of mechanic and electromagnetic brake and others, by this way to make sure no matter what condition it will be, the braking will be performed effectively and no risk at all.

The said cable rack is consisted of cable rack, the track of cable rack, the pulley or track of cable rack, frictional idler pulley and so on. According to the different structure, cable rack can be divided into fixed cable rack and retractile cable rack.

The track of cable rack is fixed on the base of the cable winder to limit the fixed cable rack, the cable rack can move forward and backward on the track, the method of friction adopted can be ball bearing, roller bearing, needle bearing and so on, also, the sliding friction through grease, graphite and other materials can be adopted.

The back end of fixed cable rack is connected with the track of the fixed cable rack by bolt, its front end stretch a proper distance out off the outside wall of the building;

The back end of retractile cable rack can be moved by the bolt, rack or chain that are installed, it can stretch out or retract back on the track of retractile cable rack, the bolt, rack or chain are driven by motor and have positioning and locking function after it stretch out, so, the retraction of the cable rack that caused by the weight of rescue cable can be avoided.

The said cable pulley or track is installed on front end of the fixed or retractile cable rack, this may allow the rescue cable be released to the ground without abrasion;

The said frictional idler pulley is a kind of synchronic frictional pulley which is driven by motor; it is installed at the back end of the cable rack to push the cable rack out and to avoid the disorderly accumulation of the rescue cable on the cable winder.

The said pulley shaft is the vertical and horizontal shaft installed at the back end of the cable rack; it can guide the rescue cable which released from the cable winding drum into the cable rack successfully, also a funneled horn can be adopted to reduce the friction of rescue cable.

This invention of cable ladder for high building rescue is floor window-style cable ladder, the cable winder is installed on the beam that above the window of the high building, the cable winding drum, decelerator motor and detent are in a row transversely, and there is s supporting stand; the fixed cable rack of window-style cable ladder is stretched out off the window and fixed at the front end of the safety rack of the sliding-down platform.

The cable ladder for high building rescue can also be building top case-style, the cable winder is a compounding structure of multi-sectional and building-block-like, the cable winding drum, decelerator motor, detent and other heavy components are installed at the back end of the case, at front of the case there is the retractile cable rack, the track of case-style retractile cable rack is rack or chain, the horizontal pulley shafts of rescue cable can be arranged at the top of the case.

Their difference with the building top rescue cable ladder is mainly the cable rack. Other principles of the cable winder and traction cable rack are the same, and they adopt the same airbag absorber and ground traction windlass.

The traction cable rack and traction tray of power cable are also be installed, the traction cable rack can be connected with the cable rack as a single structure or stretch out off the wall separately, it is consisted of bracket of traction power cable tray, traction tray of power cable, traction bracket of power cable, cable idler pulley, hook and ring and so on.

Bracket of traction power cable tray can be divided into horizontal and vertical style, their axis of rotation is driven by decelerator motor, the removable cover on the side of axis of rotation can be disassembled and can be replaced with the cable tray of different types and length according to the different condition, for example: nylon traction cable, traction power cable, steel wire traction cable or the cable made of other materials. There is the damp frictional tray installed on the traction tray of power cable, it has the functions of friction and self-tensing, and the intensity of the damp can be adjusted electrically or manually.

There are the multi-pathway contact rings on one or two sides flanges of the traction tray of power cable, they can be connected with the cover of supporting stand through sliding to close the circuit. For the contracts, the carbon brush or other arc-proof electric methods can be adopted.

The traction cable rack can be divided into fixed and retractile traction cable rack; the hook and ring at front of the traction cable are connected with the end of the cable, while the rescue cable is released from the cable winding drum, the traction cable is released from the cable tray at the same time, and it goes down vertically through the cable idler pulley; the traction cable can be used as power cable and also as the traction rope; when cleaning the outside wall or the fireman need to perform the rescue in the air, the up-and-down movements can be controlled manually through the traction cable released from the traction cable rack.

The said ground airbag absorber is consisted of cushion, upper tray, shock absorption bracket, spring support, cloth cover, base tray, cable connector, ground anchor hook and other components. Its feature is when the charge through electric device or air compressor is impossible, it can depend on the elasticity of the shock absorption bracket and the stay bar of the spring, along with the rescue cable which inserted into the airbag to perform the reciprocation of “compressing/propping up” repeatedly. The wallop occurred while the escaper bringing into contact with the ground will be absorbed by both the airbag absorber and backpack airbag, thus the safety will be ensured.

The escaper from the high building can use the safety backpack sliding-down device, along with the rescue cable which is suspended aslant to slide down to the airbag absorber on the ground continuously, while the airbag absorber is deflating quickly, the backpack airbag is beginning to deflate slowly through the pressure vent to absorb the wallop with the airbag absorber together. While the litter for the wounded, wheel chair or the heavy person is sliding down, the traction rope on the traction cable rack can be used to help the sliding-down movement.

For the scissors-style or the non-scissors-style shock absorption bracket, there is a flank plate with the hole on one side, the rescue cable can cross the cushion, upper tray and the hole on the flank plate, and then insert into in the cable connector on the base tray; for the spring stay bar, the pneumatic spring or draught spring, torsional spring, band spring and other types of springs can be adopted. There are the admitting port and vent around the cloth cover to perform the quick charging and slow deflation, thus to absorb the wallop; the hook of ground anchor can be connected with the ground anchor a proper safe distance away from the basement of the high building.

The said safety backpack sliding-down device is consisted of hard back plate, pulling band, fixing band, close-fitting airbag, backpack airbag and sliding-down device. When use for the building with glass wall, a “Λ” shaped metallic shield can be added to protect the escaper to avoid being injured by the dropping fragment of glass.

The hard back band is made of the metal or plastic, and it is fixed on the back of the person through the fixing band on breast, waist and legs, thus, to protect the escaper from his head to his hip, also there are the fordable steel wire pedals.

The pulling band props up the upper, middle and lower position of the outside of the hard back band, thus the back band is almost kept horizontally, there is a hook or ring at the end of the pulling band and it can be connected with the sliding device below the sliding device.

The close-fitting airbag can not be deflated, so it can distribute the wallop evenly to the back of the escaper.

Backpack airbag is fixed on the rear of the hard back band, and the spring stay bar is installed inside or outside of the cloth cover, release the bar, the cloth cover will be propped up automatically, thus, the air will be sucked inside. There is also the air feeder and it can be connected with the tube of aerophore, when the escaper is crossing an area with the dense smoke, the fresh air inside the airbag is enough to maintain 20˜30 minutes for escaper's normal breathing.

The said ground traction windlass is consisted of cable winding components, traction cable, damp components of transmission, electric controlling parts, it can be wedged with the ground anchor which is exceed a proper safety distance away from the basement of the high building, or it can be installed on the fire engine, and a proper tension will be kept between the rescue cable which connected aslant with the cable winder and ground cable windlass and the traction cable, meanwhile a certain damp is kept to reduce the swinging of the underside of the rescue cable and to avoid the injured bumping caused by the wind between fireman and outside wall of the high building.

Cable winding components drive the cable winding drum through the motor and transmission damp components and winds or releases the traction cable.

Traction cable can be the steel wire traction cable, traction cable or the cable made of other materials, the head of the traction cable can be fixed steadily with the tip of the rescue cable.

Transmission damp components can transfer the torque of motor to the cable winding drum through the damp clutch device to realize the winding or the releasing of the rescue cable; the damp clutch adopts the damp transmission method of mechanic damp transmission which the intensity of friction can be adjusted, also the electromagnetic method or the timing motor can be adopted.

The controlling components can control the motors of the ground traction windlass, cable winder, cable rack, traction cable rack and other electric parts. It also can monitor the working condition and surroundings through the cameras installed inside and outside the rescue cable ladder.

The cable winder of the cable ladder device for high building rescue is fixed on the top of the building or on the window, its power is supplied through the triple-circuit from inside and outside of the building and cables, at peace time, the rescue cable and its tip can be stored by winding, the cable rack can be retracted into the case or inside the building, thus, the appearance of the building well be well kept.

For this kind of cable ladder device for high building rescue, one of its tip or both two tips are fixed with the rescue cable, the winding cable drum is driven by motor, also the traction cable on the traction cable rack can be used to lift the fireman quickly to perform rescue; while escaping from the high building, firstly insert the tip of the rescue cable into the airbag absorber, and then fix it on the ground anchor which is at safe distance away from the basement of the high building, thus, the people in the high building can slide down along with the rescue cable by the individual safety backpack sliding device. The capacity of a single set of device is 60˜100 persons per minute. The device which the rescue cable can perform up-and-down movements used for quick mounting up the building and for continuous escaping, such device is called “cable ladder device for high building rescue” or “cable ladder system for high building rescue”

The following form indicates the similarities and differences between this invention namely cable ladder device for high building rescue and the present windlass-like devices:

The Similarities and Differences between Cable Ladder Device for High Building Rescue and the Present Windlass-like Devices

| | | | Construction | Crane | |
|---|---|---|---|---|---|
| | Contrast | Cable Ladder | Windlass | Windlass | Jib [symbol] |
| Similarity | Winding | Yes | Yes | Yes | Yes |
| | Cable Drum | | | | |
| Similarity | Decelerator | Yes | Yes | Yes | Yes |
| | Motor | | | | |
| Differences | Installation | Windows or Top of | Ground | Beam of | Ab [symbol] |
| | Place of | High Building | Control | Crane | Jib [symbol] |
| | Drum | | Cabinet | | |
| Differences | Storage | Whole Cable Can be | Whole | Rise | Car [symbol] |
| | Method at | Winded Up | Cable Can | Pulley | Win [symbol] |
| | PeaceTime | | Not be | | |
| | | | Winded Up | | |
| Differences | Drive | Wind Up and | Electrically | Electrically | Ele [symbol] |
| | Method | Release Electrically | | | |
| | | or Manually | | | |
| Differences | Motor | AC, DC | AC Motor | AC Motor | AC |
| Differences | Power | Inside/Outside/Triple- | Single | Single | Thr [symbol] |
| | Supply | Cable | three-phase | three- | |
| | | | | phase | |
| Differences | Control | Fire Engine, | Ground | Crane | Hig [symbol] |
| | Place | Controlling Room | Control | Cabinet, | Roo [symbol] |
| | | | Cabinet | Ground | |
| Differences | Cable | Cable of Various | Normal | Normal | Nor [symbol] |
| | | Diameter/Normal | Cable | Cable | Cab [symbol] |
| | | Cable | | | |
| Differences | Retractile | Retractile/Fixed | — | Drum | Tro [symbol] |
| | Cable Rack | Cable Rack | | Moves Left | Mov [symbol] |
| | | | | and Right | Forv [symbol] |
| | | | | | Bac [symbol] |
| Differences | Idler Pulley | Bolt/Rack/Chain | — | — | — |
| | of Retractile | TRack | | | |
| | Cable Rack | | | | |
| Differences | Pulley or | Pulley Guide Cable | — | — | — |
| | Track of | Out | | | |
| | Cable | | | | |
| Differences | Frictional | Electric Frictional | — | — | — |
| | Idler Pulley | Idler Pulley(optional) | | | |
| Differences | Vertical | Confine Range of | — | — | — |
| | Shaft of Idler | Cable Vertically | | | |
| | Pulley | | | | |
| Differences | Horizontal | Confine Range of | — | — | — |
| | Shaft of Idler | Cable Horizontally | | | |
| | Pulley | | | | |
| Differences | Traction | Flex Synchronously | — | — | — |
| | Cable Rack | with Cable Rack | | | |
| Differences | Cable | Safety Displacement | — | — | — |
| | Displacement | Device at Rear | | | |
| | Detector | | | | |
| Differences | Ground | Ensure Safe Landing | — | — | — |
| | Airbag | | | | |
| | Absorber | | | | |
| Differences | Ground | Reduce Swinging Of | — | — | — |
| | Windlass | the End of Cable | | | |

The following components can meet the demand of quick sliding down escaping

| | | | | | |
|---|---|---|---|---|---|
| Escaping | Ground Airbag | Necessary | — | — | — |
| | Absorber | | | | |
| Escaping | Safety | Ensure Sliding Down at Safe | — | — | — |
| | Backpack | Speed | | | |
| | Sliding Device | | | | |
| Escaping | Sliding Down | The Sliding Down Device | — | — | — |
| | Platform | Can be Connected Easily | | | |
| Escaping | Fordable | Mounting On the Sill Easily | — | — | — |
| | Staircase | | | | |

The following components can meet the demand of quick mounting and rescue

| | | | | | |
|---|---|---|---|---|---|
| Mounting | Ground Airbag Absorber | Necessary | — | — | — |
| | Safety Backpack | Ensure Sliding | — | — | — |
| | Sliding-down Device | Down at | | | |
| | | Safe Speed | | | |
| | Ground Traction | Necessary | | | — |
| | Windlass | | | | |

The following components can meet the demand of cleaning of the outside wall of high building

| | | | | | |
|---|---|---|---|---|---|
| Cleaning | Traction Cable | Flex Synchronously with | — | — | — |
| | Rack | Cable Rack | | | |
| | Cable and | Up-and-down Can be | — | — | — |
| | Controller | controlled in the air | | | |
| | Ground | Reduce Swinging of the End | — | — | — |
| | Traction | of Cable | | | |
| | Windlass | | | | |

Beneficial Effect

If this invention, namely the cable ladder device for high building rescue is installed on the top or the windows of any high or super-high building, the rescue cable can be controlled by the fire engine, or traction the cable of cable rack to lift a group of firemen to the high building, thus, with the high level of speed and effectiveness, safety of the firemen who are mounting outside the building is ensured, and their physical strength will be saved. Furthermore, the device of this invention can be used more than one time, this can reduce the cost of the utilization of cable ladder device for high building rescue significantly.

Having installed the cable ladder device for high building rescue, the escaper can mount on the sliding-down platform and land on the ground airbag absorber safely by the safety backpack sliding down device.

Having installed the cable ladder device for high building rescue, the fireman can carry the safety backpack sliding-down device, mount onto the high building quickly and safely with the damp of the ground windlass.

### BRIEF DESCRIPTION OF THE DRAWINGS

Drawing 1 is the plan view of this invention, namely the cable ladder device for high building rescue.

Drawing 2 A is the front view and side elevation of the screw transmission mechanism of retractile cable rack.

Drawing 2 B is the front view and side elevation of rack transmission mechanism of retractile cable rack.

Drawing 2 C is the front view and side elevation of chain transmission mechanism of retractile cable rack.

Drawing 3 is the front view and side elevation of fixed cable rack

Drawing 4 is the plan view and front view of rescue cable winder's frictional idler pulley of the building top style.

Drawing 5 is the front view and side elevation of the floor window-style cable winder.

Drawing 6 is the expended view of building top case-style cable ladder and turn-over cable rack. Drawing 6 also is the front view and side elevation of the cable winder of building top case-style.

Drawing 7 is the front view and side elevation of building top case-style cable winder.

### DETAIL DESCRIPTION OF THE DRAWINGS

As the drawings indicate: cable winder 1, cable winder drum 2, decelerator motor 3, detent 4, rescue cable 5, cable rack 6, cable rack track 7, pulley or track of cable 8, frictional idler pulley 9, vertical pulley shaft 10, horizontal pulley shaft 11, traction cable rack 12, tip of the cable 13, safety displacement device for cable winder 14, weight 15, stainless steel shield 16, retractile cable rack track 20, screw of retractile cable rack 21, internal screw bush 22, rack of retractile cable rack 23, gear 24, chain of retractile cable rack 25, chain wheel 26, fixed cable rack 27, idler pulley of fixed cable track 28, positioning screw 29, motor of frictional idler pulley 31, sliding-down platform of cable ladder 40, fordable staircase 41, floor of corridor 42, fixed cable rack of window cable ladder 43, turn-over cable rack of window cable ladder 44, protective stand of sliding-down platform 45, active door of case-style cable rack 46, airbag absorber 50, traction tray of power cable 51, outside wall 99, building's top 100.

Detailed Method of Practice

The cable ladder device for high building rescue is the device installed on the top of the high building 100 and the outside wall of the window 99, it is the cable ladder device for rescue and can be controlled from fire engine, it is consisted of cable winder 1, airbag absorber 50, traction tray of power cable 51 and other components. The cable ladder device for high building rescue is driven by triple-circuit, and it can be switched freely and can be controlled from both inside and outside of building; according to the different place of installation, the cable ladder device for high building rescue can be divided into building top cable ladder, building top case-style cable ladder, floor window-style cable ladder and many others.

As indicated by drawing 1, the cable ladder device for high building rescue is put on the top 100 of the high building, it can be driven by triple-circuit power supply, switched freely and the system can be and controlled from both inside and outside of building, more than one cable ladders can form a local area network or wide area monitoring network. The cable rack 6 of the cable ladder stretches a proper distance out off the outside wall 99 of fire-fighting side, and it can release or wind up the rescue cable 13, at the end of the cable winder, there is a safety displacement device 14 and weight 15, thus the turning-over can be avoided, the whole cable winding device is covered by stainless steel shield 16.

In the cable winder 1, there are cable winding drum 2, decorator motor 3, detent 4, rescue cable 5 can be released to the ground through the cable rack 6, the idler pulley of cable rack 7 is fix on the base tray of cable winder, the cable pulley or track 8 can release the rescue cable to ground without any damage, frictional idler pulley 9 is installed at the rear side of the cable rack 6, the vertical idler pulley shaft 10 and horizontal idler pulley shaft 11 can confine the movements of rescue cable both vertically and horizontally, traction cable rack 12 can be connected with the cable rack together and it also can stretch out off the outside wall, cable's tip 13 can be inserted into the cable connector of the airbag absorber.

Drawing 2 is the front view and side elevation of three kind of transmission mechanism of cable ladder device for high building rescue.

Drawing 2 A is the front view and side elevation of the screw transmission mechanism of retractile cable rack, the lower part of cable rack 6 can be moved f on the track 20, through the screw 21 is fixed inside the track, internal screw bush 22 can be moved forward and backward.

Drawing 2 B is the front view and side elevation of rack transmission mechanism of retractile cable rack, though the gear 24 of retractile cable rack which fixed in the track, the rack 23 fixed under the cable rack can be moved forward and backward.

Drawing 2 C is the front view and side elevation of chain transmission mechanism of retractile cable rack, though the chain wheel 26 of retractile cable rack which fixed in the track, the chain 25 fixed under the cable rack can be moved forward and backward.

Drawing 3 is the front view and side elevation of fixed cable rack, the front side of the fixed cable rack 27 stretches a proper distance out off the outside wall 99, its rear is connected by bolt with the positioning screw 29 which is fixed on the track 28 of the cable rack, the top and sides of the fixed cable rack is covered by a protective shield made of stainless steel.

Drawing 4 is the plan view and front view of rescue cable winder's frictional idler pulley of the building top style, the frictional idler pulley 9 is installed on the rear of the cable rack, the idler pulley is driven rotated by motor 31 to give the friction to rescue cable 5, guided by vertical idler pulley shaft 10 and horizontal idler pulley shaft 11, the rescue cable will be released along the cable rack 6 and its front pulley towards the ground;

The rear side of the traction cable rack 12 is the traction tray of power cable, it is in charge of the releasing and winding up of the power cable, when rescue is being performed, the traction cable can be used a safety rope, when the air rescue or the cleaning of the building is being performed, it can be used as a traction cable with high level of intensity.

Drawing 5 is the front view and side elevation of the floor window-style cable winder, the cable winder 1 is installed on the beam that above the window of the high building, the cable winding drum 2, decelerator motor 3 and detent 4 are in a row transversely, the fixed cable rack 43 of window-style cable ladder or the turning-over cable rack 44 is stretched out off the window and fixed at the upper of the safety rack of the sliding-down platform 45, the rescue cable 5 is suspended out off the window through the pulley or track 8; the protective stand 45 of sliding-down platform is fixed on the outside wall 99 by screw, the sliding-down platform 40 of the cable ladder can be retracted and hung outside the window, and it will cover the fordable staircase 41, thus, the sun shine of the corridor window won't be affected, airbag absorber 50 can be hung over under the sill, also it can be put in the place of basement, insert the tip 13 of the rescue cable 5 into the airbag absorber connector when it is about to be used.

Drawing 6 is the expended view of building top case-style cable ladder and turn-over cable rack, when escaping, firstly, raise the sliding-down platform 40 of the cable ladder, and push it out off the window and on the protective stand 45 of the sliding-down platform, then fix it steadily, with that, pull the fordable staircase 41 out and put it on the floor 42 of the corridor, then you can step on the sliding-down platform; at peace time, the turning-over cable rack 44 can be stored at the rear of the cable winding drum, while using, it can be manipulated electrically or manually to turn to outside of the window and to connect it on the top of the protective stand 45 of the sliding-downing platform, the rescue cable 5 can be hung out off the window through the pulley or track of the cable.

Drawing 7 is the front view and side elevation of building top case-style cable winder, is has a larger cable winder with a multi-sectional and building-block-like structure, the cable winding drum 2 and decelerator motor, detent and other heavy components are installed at the rear of the case, at front of the case there is the retractile cable rack 6, pulley of the cable 8, there is an active door 46 at the front floor of the case, the active door 46 will only be open for sliding-down when the escaper is ready; case-style retractile track 20 can be rack or chain, it can be manipulated both electrically and manually, it can stretch a proper distance out off the outside wall 99 of the high building, it also has the functions of positioning and locking; the horizontal pulley shafts of rescue cable can be arranged at the top of the case, rescue cable can be drooped towards the ground through the cable pulley 8; the two sides of the case can be raised to help more people to get into the case, thus, to realize the evacuation continuously. The airbag absorber 50 can be connected with the retractile bracket 6, also it can be placed on the basement.

What is claimed is:

1. Cable ladder device for high building rescue comprising:
cable winder;
cable rack of said cable winder stretching a proper distance out off outside wall of a high building and releasing or winding up a rescue cable;
ground airbag absorber;
the tip of said rescue cable can be fixed with said ground airbag absorber or the ground itself;
a safety displacement device and weight at the rear of said cable winder.

2. The cable ladder device of claim 1, wherein said cable winder includes cable winding drum, decelerator motor, detent and traction cable rack; said cable rack includes retractile cable rack, fixed or turning-over cable rack; there is a pulley or track for releasing and winding up of said rescue cable; said retractile cable rack flexes on said track and said track is fixed on a chassis or a building; there is frictional idler pulleys on the rear of said cable rack, vertical and horizontal idler pulley shafts are to restrict the movements of said rescue cable both vertically and horizontally, the tip of said rescue cable can be connected with the connector of said airbag absorber.

3. The cable ladder device of claim 1, wherein it adopts screw or rack or chain transmission mechanisms:
Screw-style transmission mechanism, an internal screw bush is moved through a screw in the track of said cable rack, thus, to realize the forward and backward movement of the retractile cable rack, additionally it has position locking function;
Rack-style transmission mechanism, the rack is moved through a gear in the track of said cable rack, thus, to realize the forward and backward movement of the retractile cable rack, additionally it has position locking function;
Chain-style transmission mechanism, a chain is moved through a chain wheel in the track of said cable rack, thus, to realize the forward and backward movement of the retractile cable rack, additionally it has position locking function.

4. The cable ladder device of claim 2, wherein it adopts screw or rack or chain transmission mechanisms:
Screw-style transmission mechanism, an internal screw bush is moved through a screw in the track of said cable rack, thus, to realize the forward and backward movement of the retractile cable rack, additionally it has position locking function;
Rack-style transmission mechanism, the rack is moved through a gear in the track of said cable rack, thus, to realize the forward and backward movement of the retractile cable rack, additionally it has position locking function;
Chain-style transmission mechanism, a chain is moved through a chain wheel in the track of said cable rack, thus, to realize the forward and backward movement of the retractile cable rack, additionally it has position locking function.

5. The cable ladder device of claim 1 and 2, wherein the head of said cable rack stretches a proper distance away from the outside wall of said building, a screw hole of the cable rack's rear or of the fixed cable rack's track is connected by a screw, the top and sides of said fixed cable race is equipped with a protective shield.

6. The cable ladder device of claim 2, wherein the head of said cable rack stretches a proper distance away from the outside wall of said building, a screw hole of the cable rack's rear or of the fixed cable rack's track is connected by a screw, the top and sides of said fixed cable race is equipped with a protective shield.

7. The cable ladder device of claim 1, wherein there is an additional traction cable rack and traction tray of power cable, the traction cable rack is connected with said cable rack together and stretched out off the window, a traction tray of power cable is at rear of the traction cable rack to release or wind up a power cable or the cable.

8. The cable ladder device of claim 2, wherein there is an additional traction cable rack and traction tray of power cable, the traction cable rack is connected with said cable rack together and stretched out off the window, a traction tray of power cable is at rear of the traction cable rack to release or wind up a power cable or the cable.

9. The cable ladder device claim 1, wherein said cable winder is installed on a beam that above the window of the high building, a cable winding drum, decelerator motor and detent are in a row transversely, and there is s supporting stand; said fixed cable rack of window-style cable ladder is stretched out off the window and fixed at a upper end of a safety rack of a sliding-down platform, the rescue device is hung over out off the window through the pulley or track at front of said cable rack; a protective stand of said sliding-down platform is fixed with the outside wall through screws, said sliding-down platform can be retracted inside the window and hung vertically, and a fordable staircase can be covered; said airbag absorber can be hung under the sill or be placed on the ground close to the basement.

10. The cable ladder device claim 2, wherein said cable winder is installed on a beam that above the window of the high building, said cable winding drum, decelerator motor and detent are in a row transversely, and there is s supporting stand; said fixed cable rack of window-style cable ladder is stretched out off the window and fixed at a upper end of a safety rack of a sliding-down platform, the rescue device is hung over out off the window through said pulley or track at front of said cable rack; a protective stand of said sliding-down plat form is fixed with the outside wall through screws, said sliding-down platform can be retracted inside the window and hung vertically, and a fordable staircase can be covered; said airbag absorber can be hung under the sill or be placed on the ground close to the basement.

11. The cable ladder device of claim 1, wherein said cable ladder can be building top case-style, said cable winder is a compounding structure of multi-sectional and building-block-like, a cable winding drum, decelerator motor, detent and other heavy components are installed at the back end of said case, at front of said case there is a retractile cable rack, the track of the case-style retractile cable rack is a rack or a chain, horizontal pulley shafts of said rescue cable can be arranged at the top of the case, said rescue cable is drooped toward the ground through the pulley at front of said retractile cable rack; said airbag absorber can be hung at front of said cable rack, or be placed on the ground close to the basement.

12. The cable ladder device of claim 2, wherein said cable ladder can be building top case-style, said cable winder is a compounding structure of multi-sectional and building-block-like, said cable winding drum, decelerator motor, detent and other heavy components are installed at the back end of said case, at front of said case there is said retractile cable rack, the track of the case-style retractile cable rack is a rack or a chain, said horizontal pulley shafts of said rescue cable can be arranged at the top of the case, said rescue cable is drooped toward the ground through the pulley at front of said retractile cable rack; said airbag absorber can be hung at front of said cable rack, or be placed on the ground close to the basement.

13. The cable ladder device of claim 1, wherein said ground airbag absorber comprises a shock absorption bracket, spring stay bar, cloth cover, chassis, cable connector and hook of ground anchor, there is a side plate with a hole on one side of said shock absorption bracket, the tip of said rescue cable can across a cushion, upper plate and the side plate's hole, and inserts into the cable connector on chassis, said airbag performs a reciprocation of pressing down and propping up along with said rescue cable.

14. The cable ladder device of claim 2, wherein said ground airbag absorber comprises a shock absorption bracket, spring stay bar, cloth cover, chassis, cable connector and hook of ground anchor, there is a side plate with a hole on one side of said shock absorption bracket, the tip of said rescue cable can across a cushion, upper plate and the side plate's hole, and inserts into the cable connector on chassis, said airbag performs a reciprocation of pressing down and propping up along with said rescue cable.

15. The cable ladder device of claim 1, wherein a safety backpack is equipped with the cable ladder device, it comprises a hard back plate, pulling band, fixing band, close-fitting airbag, backpack airbag and sliding-down device; said hard back band is fixed on the back of the person through a fixing band on breast, waist and legs, said pulling band props up a upper, middle and lower position of the outside of said hard back band, six tips of said pulling band are equipped with hooks and rings and they can be connected with the underside of sliding-down device.

16. The cable ladder device of claim 2, wherein a safety backpack is equipped with the cable ladder device, it comprises a hard back plate, pulling band, fixing band, close-fitting airbag, backpack airbag and sliding-down device; said hard back band is fixed on the back of the person through a fixing band on breast, waist and legs, said pulling band props up a upper, middle and lower position of the outside of said hard back band, six tips of said pulling band are equipped with hooks and rings and they can be connected with the underside of sliding-down device.

17. The cable ladder device of claim 1, wherein a ground windlass is equipped, it includes winding parts, traction cables, damp transmission components, it can connected with a anchor which has a safe distance away from the building or with a fire engine, said traction cable hangs on the tip of said rescue cable, thus, a proper tension between said rescue cable and traction cable which separately connected aslant with said rescue cable winder of cable ladder and said ground windlass.

18. The cable ladder device of claim 2, wherein a ground windlass is equipped, it includes winding parts, traction cables, damp transmission components, it can connected with a anchor which has a safe distance away from the building or with a fire engine, said traction cable hangs on the tip of said rescue cable, thus, a proper tension between said rescue cable and traction cable which separately connected aslant with said rescue cable winder of cable ladder and said ground windlass.
